(19) United States
(12) Patent Application Publication
(10) Pub. No.: US 2008/0035408 A1
(43) Pub. Date: Feb. 14, 2008

(54) REVERSIBLE DRIVING ARRANGEMENTS

(75) Inventors: Erich Gristenbrei, Biessenhofen (DE); Jurgen Knobloch, Ruderatshofen (DE); Helmut Mannsbart, Buchloe (DE)

Correspondence Address: TROUTMAN SANDERS LLP, 600 PEACHTREE STREET , NE, ATLANTA, GA, 30308, US

(73) Assignee: AGCO GmbH, Marktoberdorf (DE)

(21) Appl. No.: 11/835,843

(22) Filed: Aug. 8, 2007

(30) Foreign Application Priority Data
Aug. 9, 2006 (GB) 0615771.3

(51) Int. Cl. B60N 2/14; B60K 26/00

(52) U.S. Cl. 180/329; 108/139; 280/775; 297/344.21

(57) ABSTRACT

A reversible driving arrangement for a tractor or any other vehicle in which a driver's operating station (10) including a seat (11), control panel (13) and steering wheel (12) can be rotated between a forward driving position and a reverse driving position. The operating station (10) is rotatably mounted on a floor of the vehicle via a fluid pressure operated rotary actuator (14) which includes a radially extending vane (28) which can be pressurised on one side or the other to assist in rotating the operating station between the forward and reverse driving positions. The rotary actuator is preferably pneumatically operated and part (22b, 22c) of the operator's station (10) pivots upwardly to a retracted position prior to rotation between the forward and reverse driving positions to reduce the overhang of the station.

### BENEFIT CLAIM

This application is based on, and claims the benefit of priority to, UK application GB 0615771.3, filed 9 Aug. 2006, which priority application is hereby incorporated by reference.

### BACKGROUND OF THE INVENTION

1. Field of the Invention

This invention relates to reversible driving arrangements for tractors or any other vehicles in which a driver's operating station including a seat, a control panel and a steering wheel can be rotated between a forward driving position for driving the vehicle in a forward driving direction and a reverse driving position for driving the vehicle in a reverse driving direction.

2. Description of Related Art

Examples of such reversible driving arrangements are well known and are shown, for example, in the Applicant's own prior art arrangement of DE 3807848.

As the complexity and weight of driver's operating stations increases, due to the inclusion of complex control devices mounted on for example, the arms of the driver's seat, the inclusion of ever increasingly large display screens, the use of active seat suspension and ventilation, and the mounting of control pedals and parts of the braking system on the steering column etc, the force required to rotate the driver's operating station between the forward and reverse driving positions has also increased due to weight of the extra components and to the number of hoses, wires and other connections which are needed to connect the reversible station with the chassis of the vehicle and which must be twisted when the reversible station is rotated between its two positions.

It is an object of the present invention to provide a reversible driving arrangement which overcomes the above increasing problem.

### BRIEF SUMMARY OF THE INVENTION

Thus according to the present invention there is provided a reversible driving arrangement for a tractor or any other vehicle in which a driver's operating station including a seat, control panel and steering wheel can be rotated between a forward driving position and a reverse driving position, the operating station being rotatably mounted on a floor of the vehicle via a fluid pressure operated rotary actuator which includes a radially extending vane which can be pressurised on one side or the other to assist in rotating the operating station between the forward and reverse driving positions.

In a preferred construction the rotary actuator includes an annular actuating chamber formed between a first component non rotatable fixed to the floor of the vehicle and a second component on which the operating station is mounted and which is rotatable relative to the first component, the vane rotating with to the second component and a second radially extending vane being attached to the first component, so that, by pressurising the portion of the annular chamber between one side of the vane and the second vane, the second component and thus the operating station can be rotated in one direction, and, by pressurising the portion of the annular chamber between the other side of the vane and the second vane, the second component and thus the operating station can be rotated in the other direction.

To facilitate rotation an annular bearing, which may be of any suitable type, is provided between the first and second components to support the rotation of the operator's station.

In a preferred construction the first component is of generally annular form and defines a U-shaped cross-section chamber with the ends of the limbs of the U-shaped cross-section extending towards the axis of rotation of the second component, the annular chamber being sealed by a portion of the second component which extends within the centre of the first component and surrounds the axis of rotation of the second component.

Conveniently a lower side of the U-shaped cross-section chamber is provided with two ports for the alternative admission of pressurised fluid to rotate the second component relative to the first component in opposite directions. These ports are located on opposite sides of the vane in zones of the U-shaped cross-section chamber which are not swept by the vane.

In a preferred arrangement each vane comprises a support member secured to the respective first or second component, the support member having a projecting seal support portion, a generally ring-like seal surrounding the projecting seal support portion on a seal supporting shoulder, a mounting plate bolted or otherwise secured to the seal support portion to hold the seal between the plate and the seal supporting shoulder to hold the seal into sealing contact with the surrounding walls of the associated actuator chamber.

A latch is preferably provided to lock the station in the forward or reverse driving position, the latch being releasable by the driver.

As will be appreciated connections for the steering wheel, the control panel and other functions and communications systems extend through the centre of the first and second components in a direction generally parallel to the axis of rotation of the work station.

In a preferred arrangement, parts of the operator's station pivot upwardly prior to rotation between the forward and reverse driving positions to reduce the overhang of the station.

A fluid flow control valve may be provided which controls the flow of fluid through the two chamber ports to control the direction of rotation of the second component relative to the first component, a first sensing means may be provided to detect whether the station is currently in the forward or reverse driving position, a second sensing means may be provided to detect when the operating station has been pivoted upwardly to the retracted position, and a control means may be is provided which on receipt of signals from the first and second sensing means issues a signal to the fluid flow control valve to connect the appropriate chamber port to the pressurised fluid to assist in rotating the station to the other driving position.

### BRIEF DESCRIPTION OF THE DRAWINGS

One embodiment of the present invention will now be described, by way of example only, with reference to the accompanying drawings in which: —

FIG. 1 shows a side view of a driver's operating station in accordance with the present invention in the forward driving position;

FIG. 2 shows a side view of a driver's operating station in accordance with the present invention in the reverse driving position;

FIG. 3 is a view from beneath of a rotary actuator used in the operating station of FIGS. 1 and 2;

FIG. 4 is as side view in the direction of the arrow Y of FIG. 3;

FIG. 5 is a section on the line A-A of FIG. 3;

FIGS. 6 and 7 are perspective views from above and below respectively of the actuator of FIG. 3;

FIG. 8 is a section on the line C-C of FIG. 4;

FIG. 9 is an exploded view of the actuator of FIGS. 6 and 7;

FIG. 10 shows a horizontal section through the actuator with the pneumatic supply system indicated diagrammatically;

FIG. 11 shows on a large scale the detail circled at G on FIG. 8;

FIG. 12 shows on a larger scale the detail circled at H in FIG. 5;

FIG. 13 shows in plan details of the hydraulic hose arrangement used to supply the steering unit mounted on the operating station;

FIG. 14 shows a vertical section through the hose arrangement of FIG. 13;

FIG. 15 shows a side view of the driver's operating station with the sub-frame which supports the steering wheel and pedals etc pivoted upwardly prior to rotation to the reverse driving position;

FIG. 16 shows a perspective view of the part of the driver's operating station showing the latching pin which locks the station in the forward and reverse driving positions, and

FIG. 17 shows on a larger scale the details of the latching pin of FIG. 16.

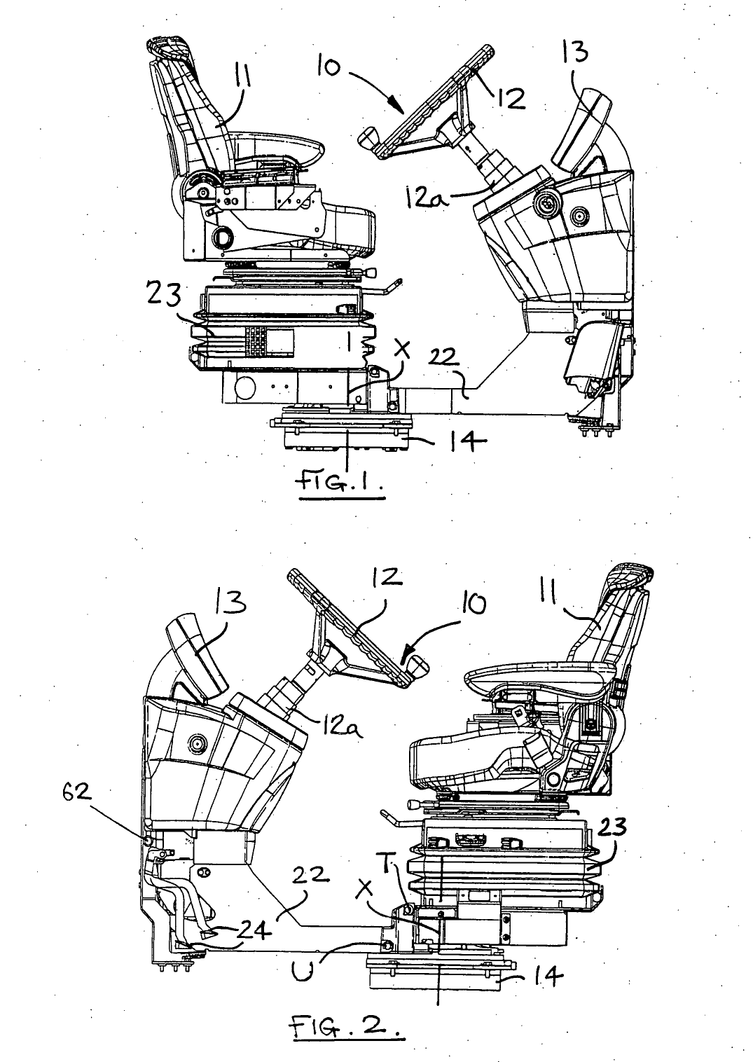

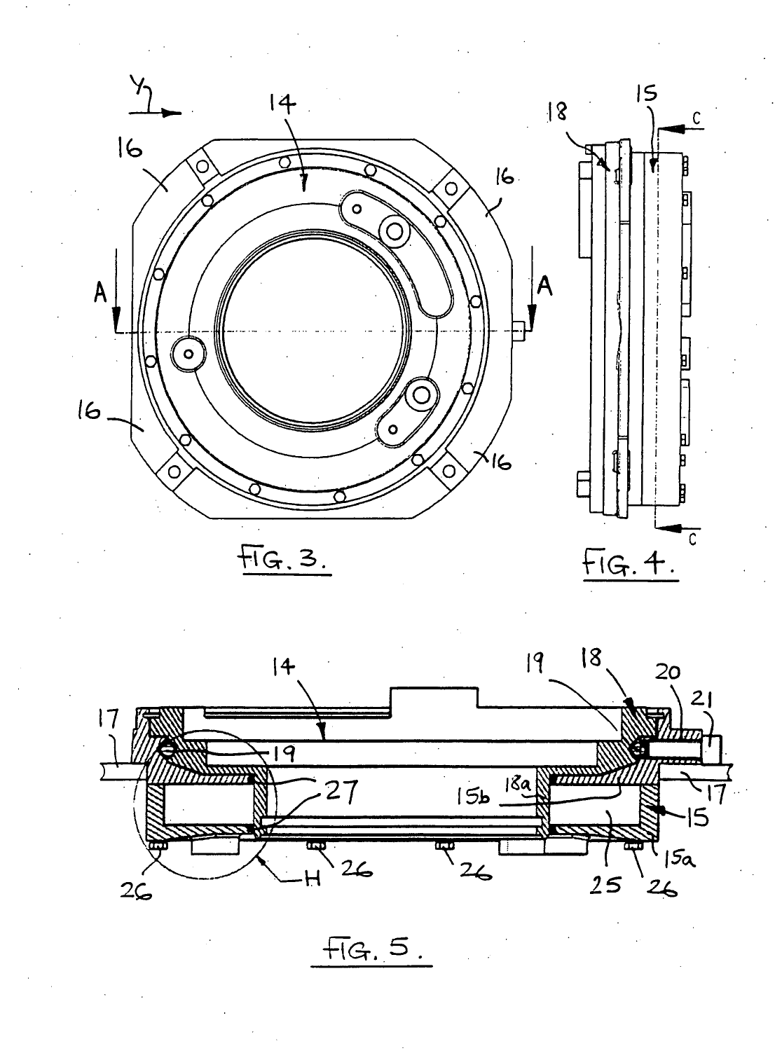

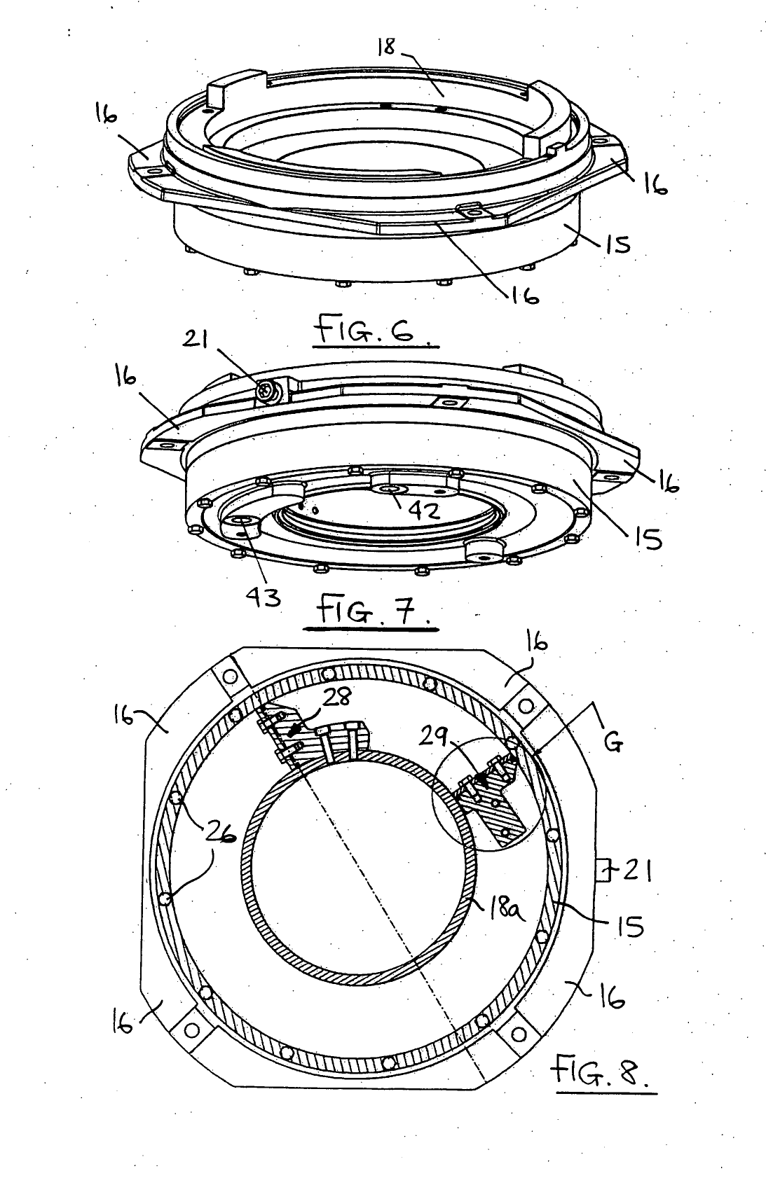

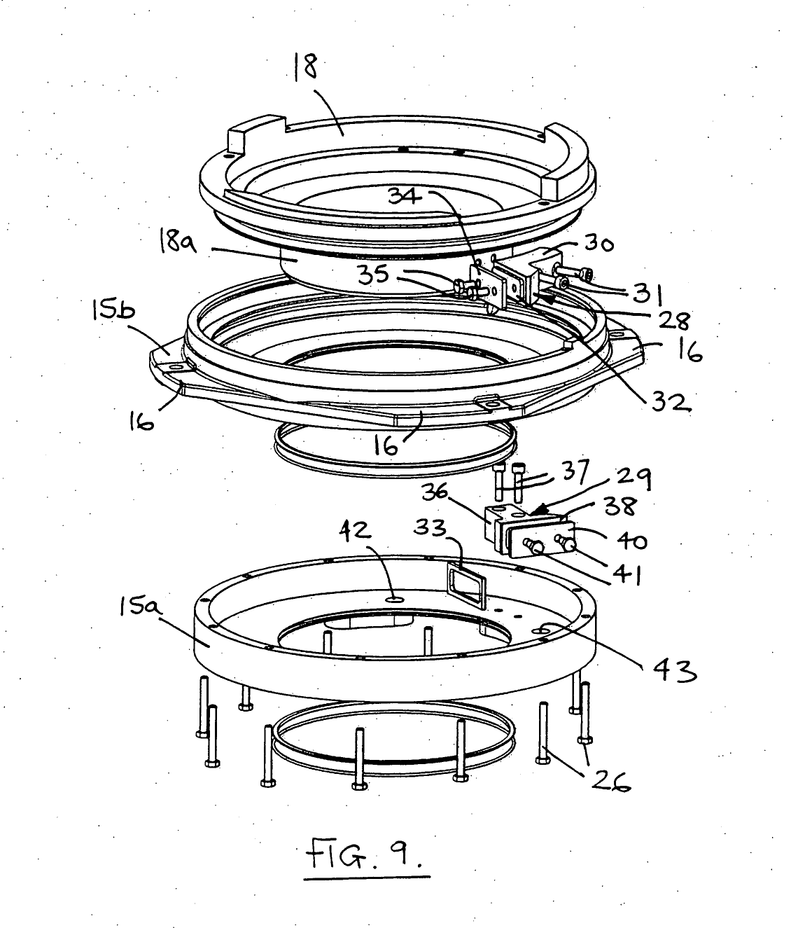

### DETAILED DESCRIPTION OF PREFERRED EMBODIMENTS

Referring to the drawings, a reversible driving arrangement for a driver's operating station of a tractor is shown at 10 which includes an operator's seat 11, a steering wheel 12 and associated steering column 12a, and a display/control panel 13.

In accordance with the present invention, in order to provide for the rotation of the operating station between the forward and reverse driving positions about and axis X, the operating station is mounted on a rotary actuator 14 which is pneumatically operated. The basic constructional details of the actuator 14 are best seen in FIG. 5. The actuator comprises a lower fixed component 15 which is bolted via flanges 16 to the floor 17 of the tractor cab and an upper component 18 which is rotatable relative to the lower fixed component 15 via bearings 19 which support the two components 15 and 18 for relative rotation through 180°. In the example described, the bearings are of the ball bearing type and are introduced between the components 15 and 16 via an inlet passage 20 which is closed by a bolt 21. Any other suitable form of bearing could be used to support the upper component 18 relative to the lower component 15.

The operating station is supported from the upper rotatable component 18 on a sub-frame 22 which supports the seat suspension 23 and the steering column 12a with associated brake, clutch and accelerator pedals 24 and all the ancillary components such as the hydraulic steering unit and possibly also the brake controls valves etc.

The sub-frame 22 is in three parts 22a, 22b and 22c which can pivot relative to each other as is shown in FIG. 15. Parts 22a and 22b pivot about axes T and U thus allowing part 22b to rotate upwardly as indicated by arrow V and part 22c also rotates relative to part 22b as indicated by arrow W so that the operating station assumes the position show in FIG. 15 thus reducing the overhang of steering wheel 12, steering column 12a and pedals 24 etc in order to facilitate the rotation of the operating station between its forward and reverse driving positions.

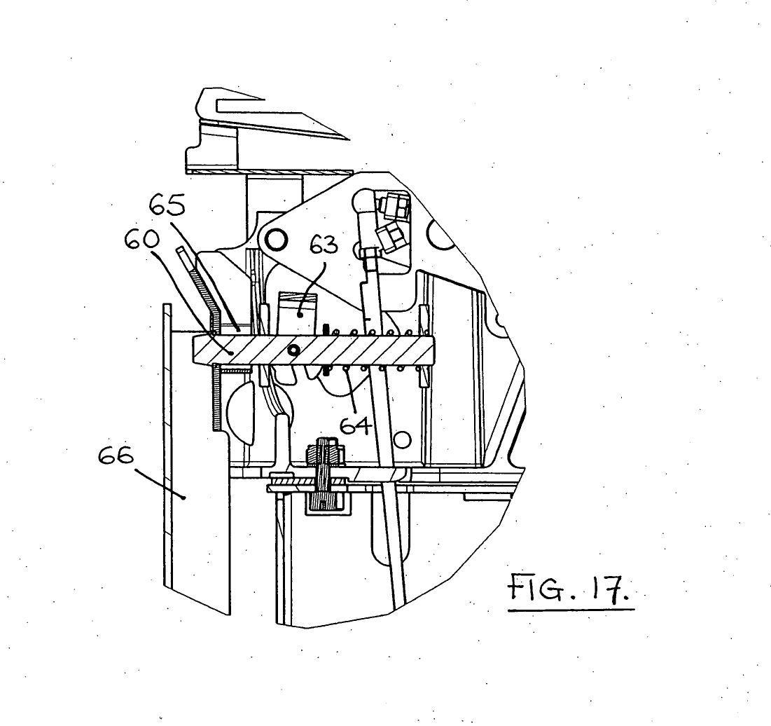

A latch pin 60 (see FIGS. 16 and 17) carried on sub frame part 22c locks the operators station in the forward and reverse driving positions. This latch pin is operated by a lever 61 provided with a handle 62. Lever 61 is connected via an arm 63 with latch pin 60 which is spring loaded at 64 to its extended position. Latch pin 60 engages a socket 65 carried on a column 66 secured to the floor at the front of the cab to lock the operating station in the forward driving position. A socket 67 is secured to the rear of the cab and receives the latching pin 60 when the operating station is in the reverse driving position.

A sensor 68 detects if the operators station is in the forward or reverse driving position and a second sensor 69 detects when the sub-frame parts 22b and 22c have been pivoted to the raised position shown in FIG. 15. These sensors are connected with electronic control unit 47 as described below.

The lower component 15 of actuator 14 includes a working chamber 25 generally U-shaped cross-section. This component 15 is itself formed from a lower part 15a and an upper part 15b which are held together by bolts 26. The working chamber 25 is sealed to a central cylindrical boss 18a provided on the upper component 18 by seals 27. The bearing 19 supports the upper component 18 from the outside of upper part 15b.

To assist in the rotation of the upper component 18 relative to the lower component 15 a radially extending vane 28 is fixed to the component 18. A similar vane 29 is fixed to the stationery component 18. Details of the vane 28 and 29 are best seen in FIGS. 8, 9 and 10 from which it can be seen that the vane 28 has a support member 30 which is bolted to the upper component 18 by bolts 31. As best seen in FIG. 9 the support member 30 has a projecting seal support portion 32 on which is generally rectangular seal 33 is mounted. The seal is held on projection 32 by a plate 34 which is in turn held in place by bolts 35.

Similarly vane 29 has a support member 36 which is bolted to the lower wall of component 15 by bolts 37 and supports a rectangular seal 38 on a protecting seal support portion 39 via a plate 40 held in position by bolts 41.

Although in the arrangement described the vanes 28 and 29 are rigidly secured to the corresponding components 18 and 15 it is envisaged that some flexibility in the mounting of these vanes relative to the components on which they are mounted may be provided to take care of shock loads etc.

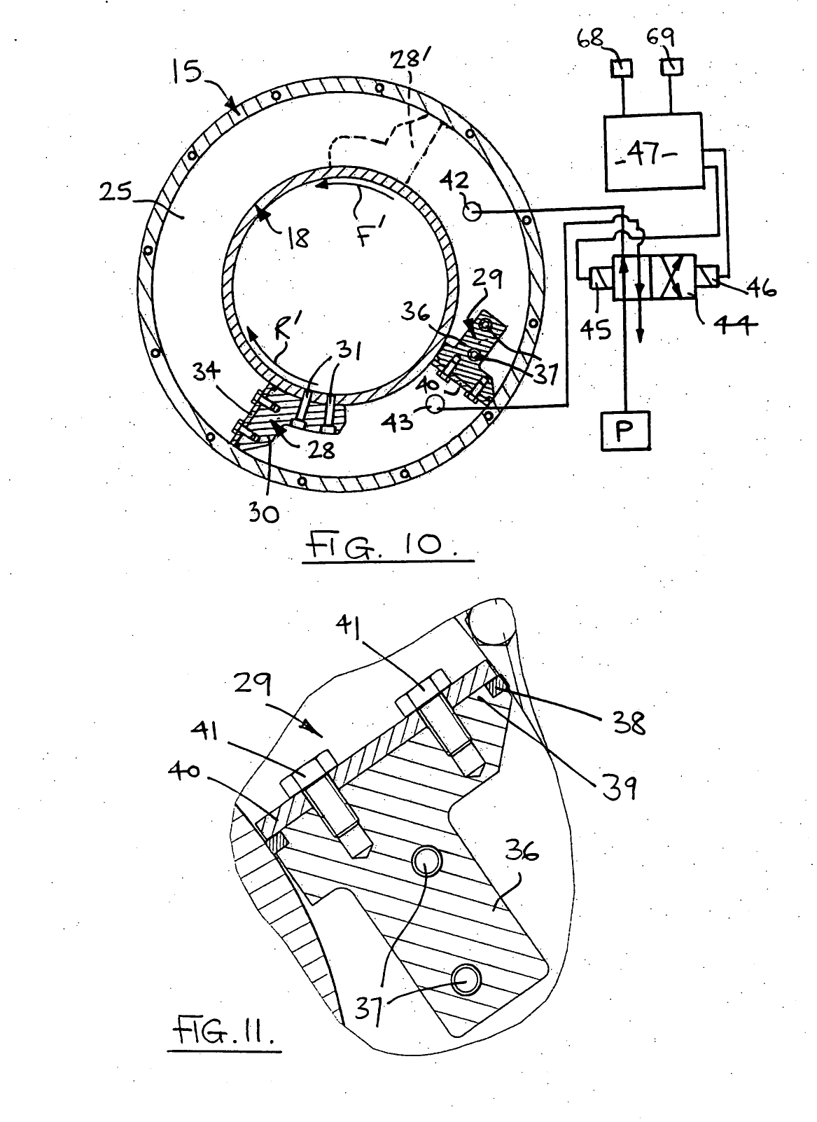

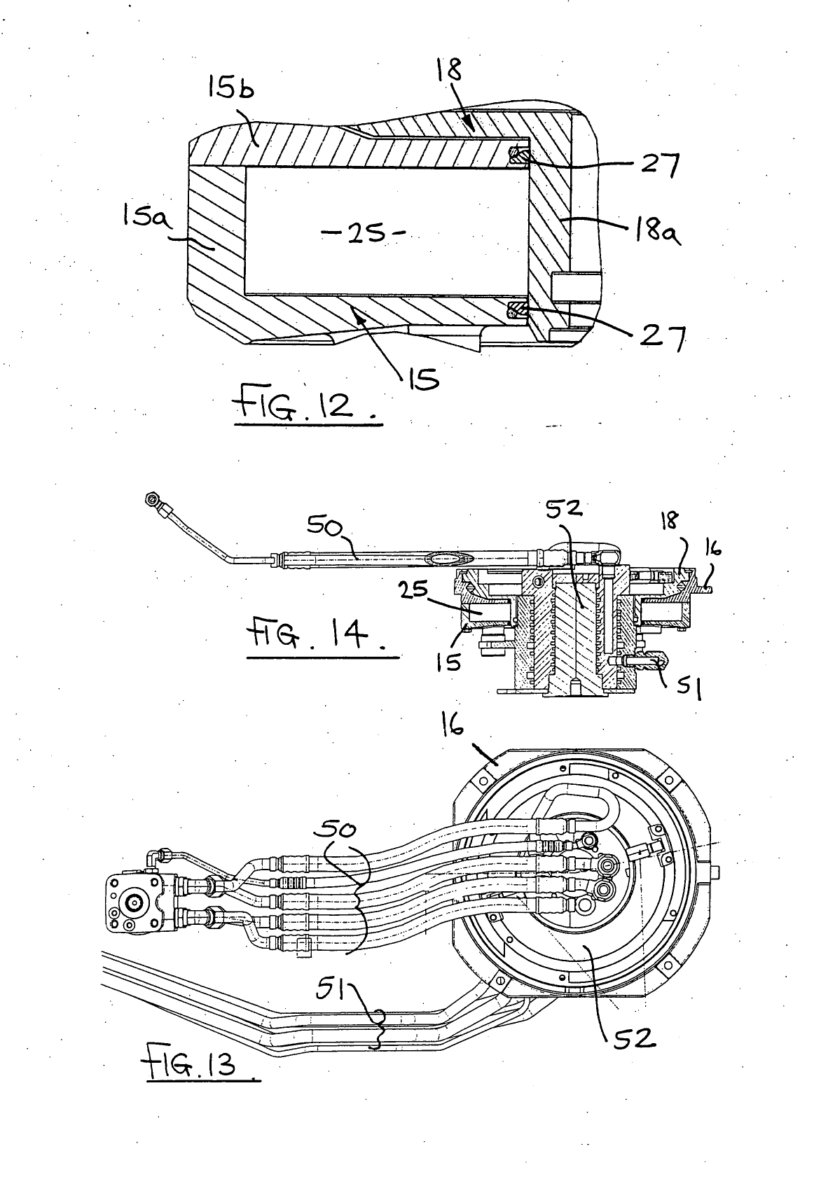

Referring to FIG. 10 this shows diagrammatically the connection of a pneumatic supply P to the working chamber at 25 of the rotary actuator 14. The working chamber is provided with two ports 42 and 43 which emerge into the working chamber through the lower wall of the chamber. These ports are connected with a control valve 44 which may be either manually directly operated or, as shown in FIG. 10, operated by solenoids 45 and 46 which are connected with an electronic control unit 47 of the tractor which controls not only the movement of the operator's work station but also many of the other functions on the tractor.

Assuming that the driver wishes to rotate the operating station from the forward driving position to the reverse position he pulls on handle 62 which rotates lever 61 in direction Z of FIG. 16 thus disengaging pin 60 from socket 65 on column 66 and allowing the driver to pivot the sub-frame parts 22b and 22c to the position shown in FIG. 15. Sensor 69 detects when the FIG. 15 position has been obtained and sensor 68 indicates that the operating station is in the forward driving position. These sensor signals are received by control unit 47 and solenoid 45 is actuated to move valve 44 to connect port 43 with the source of pneumatic pressure P thus moving vane 28 clockwise as indicated by arrow ‘R’ in FIG. 10 thus positioning the operating station in the reverse driving position indicated by the dotted detail 28′ in FIG. 10. During this mode of operation the port 42 is connected to the atmosphere. When the operating station reaches the reverse driving position the sub-frame parts 22b and 22c are lowered and the pin 60 snaps into the socket 67 to lock the operating station in this required position.

During the rotation of the operating station between the forward and reverse driving positions the connections between the turning of the steering wheel and the turning effect provided by the associated power assisting steering unit is reverse to that, for example, turning the steering wheel anti-clockwise will turn the vehicle to the left whether the vehicle is being driven from the forward or reverse driving positions. Other control functions such as the turn indicators are also switched over during the rotation between the forward and reverse driving positions.

Should the driver wish to change from the reverse driving position to the forward driving position a similar process is required. The driver pulls on handle 62 to disengage pin 60 from socket 67 and pivots the sub-frame parts 22b and 22c to the raised FIG. 15 position. The sensors 68 and 69 then initiate the actuation of solenoid 46 which moves valve 44 to connect port 42 to the source P of pneumatic pressure thus driving vane 28 in an anti-clockwise sense relative to fixed vane 29 as indicated by the arrow ‘F’. During this mode of operation the port 43 is connected to the atmosphere.

When the operating station arrives in the forward driving position the sub-frame parts 22b and 22c are lowered so that pin 60 engages socket 65. Again during the rotation between the forward and reverse driving position the steering connections and turn indicator connections are reversed.

By pressurising the moveable vane 28 on one side of the other it will be appreciated that considerable force can be generated which greatly assists the operator in moving the work station to either the forward or reverse driving positions.

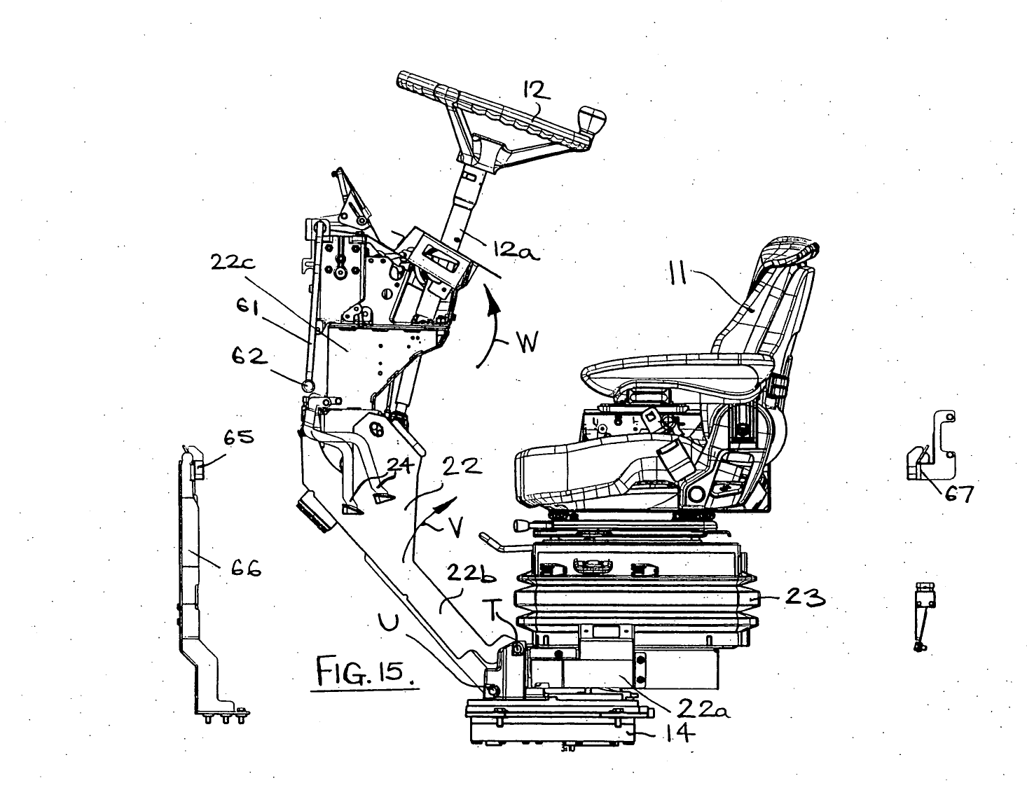

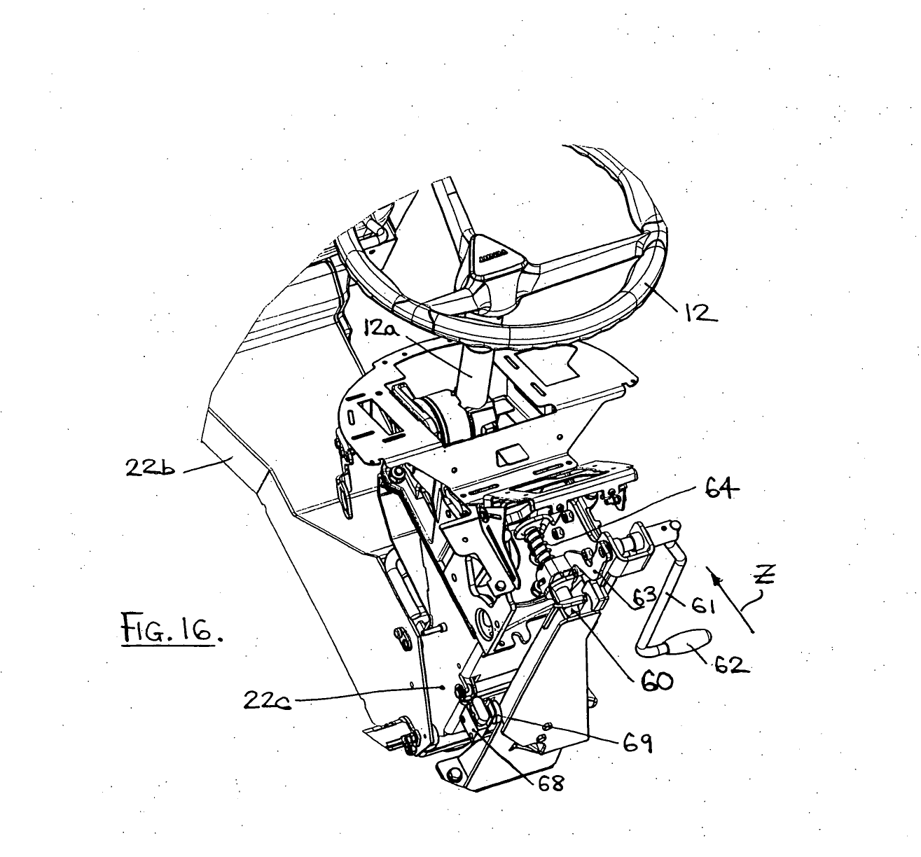

As indicated previously, the moveable driver's operating station includes complex components such as the hydraulic steering unit connected to steering wheel 12. The hose arrangement for this steering unit is shown partly in plan view and also in section in FIGS. 12 and 13. As will be appreciated, the hydraulic connections necessary to allow for the rotation of the hydraulic hoses 50 mounted on the rotatable component 18 relative to the fixed hoses 51 mounted on the stationery component 18 is complex and, since it does not form part of the present invention, will not be described in detail. It is sufficient to say that these connections are made via a unit 52 which extends down the centre of the two relative rotatable components 15 and 18 substantially in alignment with the rotation axis X of the operating station.

As will be appreciated all the other connections between the rotatable operating station and the non-rotating vehicle chassis must also pass down the centre of the relatively rotatable components 15 and 18. Again, since these connections do not form part of the present invention and will be well known to a man skilled in the art, they are not described in detail in this patent application.

We claim:

1. A reversible driving arrangement for a tractor or any other vehicle in which a driver's operating station including a seat, control panel and steering wheel can be rotated between a forward driving position and a reverse driving position, the operating station being rotatably mounted on a floor of the vehicle via a fluid pressure operated rotary actuator which includes a radially extending vane which can be pressurised on one side or the other to assist in rotating the operating station between the forward and reverse driving positions.

2. An arrangement according to claim 1 in which the rotary actuator includes an annular actuating chamber formed between a first component non rotatable fixed to the floor of the vehicle and a second component on which the operating station is mounted and which is rotatable relative to the first component, the vane rotating with to the second component and a second radially extending vane being attached to the first component, so that, by pressurising the portion of the annular chamber between one side of the vane and the second vane, the second component and thus the operating station can be rotated in one direction, and, by pressurising the portion of the annular chamber between the other side of the vane and the second vane, the second component and thus the operating station can be rotated in the other direction.

3. An arrangement according to claim 2 in which the second component is supported for rotation relative to the first component on an annular bearing between the components.

4. An arrangement according to claim 2 in which the first component is of generally annular form and defines a U-shaped cross-section chamber with the ends of the limbs of the U-shaped cross-section extending towards the axis of rotation of the second component, the annular chamber being sealed by a portion of the second component which extends within the centre of the first component and surrounds the axis of rotation of the second component.

5. An arrangement according to claim 3 in which the second component is supported for the rotation on the outside of one side of the U-shaped cross-section chamber of the first component via the annular bearing.

6. An arrangement according to claim 4 in which a lower side of the U-shaped cross-section chamber is provided with two ports for the alternative admission of pressurised fluid to rotate the second component relative to the first component in opposite directions.

7. An arrangement according to claim 6 in which the pressurised fluid is air.

8. An arrangement according to claim 2 in which the or each vane comprises a support member secured to the respective first or second component, the support member having a projecting seal support portion, a generally ring-like seal surrounding the projecting seal support portion on a seal supporting shoulder, a mounting plate bolted or otherwise secured to the seal support portion to hold the seal between the plate and the seal supporting shoulder to hold the seal into sealing contact with the surrounding walls of the associated actuator chamber.

9. An arrangement according to claim 1 provided with a latch to lock the station in the forward or reverse driving position, the latch being releasable by the driver.

10. An arrangement according to claim 2 in which the connections for the steering wheel, the control panel and other functions and communications systems extend through the centre of the first and second components in a direction generally parallel to the axis of rotation of the work station.

11. An arrangement according to claim 1 in which parts of the operator's station pivot upwardly to a retracted position prior to rotation between the forward and reverse driving positions to reduce the overhang of the station.

12. An arrangement according to claims 6 in which parts of the operator's station pivot upwardly to a retracted position prior to rotation between the forward and reverse driving positions to reduce the overhang of the station, a fluid flow control valve being provided which controls the flow of fluid through the two ports to control the direction of rotation of the second component relative to the first component, a first sensing means being provided to detect whether the station is currently in the forward or reverse driving position, a second sensing means being provided to detect when the operating station has been pivoted upwardly to the retracted position, and a control means being provided which, on receipt of signals from the first and second sensing means, issues a signal to the fluid flow control valve to connect the appropriate chamber port to the pressurised fluid to assist in rotating the station to the other driving position.
